(19) United States
(12) Patent Application Publication
(10) Pub. No.: US 2013/0113305 A1
(43) Pub. Date: May 9, 2013

(54) LINEAR VIBRATOR

(71) Applicant: Jun Kun CHOI, Suwon (KR)

(72) Inventor: Jun Kun CHOI, Suwon (KR)

(73) Assignee: SAMSUNG ELECTRO-MECHANICS CO., LTD.

(21) Appl. No.: 13/477,859

(22) Filed: May 22, 2012

(30) Foreign Application Priority Data
Nov. 3, 2011 (KR) 10-2011-0114058

(51) Int. Cl. H02K 33/00

(52) U.S. Cl. 310/15

(57) ABSTRACT

There is provided a linear vibrator including: a fixed part including a magnet generating magnetic force in an interior space having a predetermined size; a vibration part including a coil provided to face the magnet and generating electromagnetic force through interaction with the magnet, and a mass body; an elastic member coupled to the vibration part and the fixed part to thereby provide elastic force thereto; and a substrate including a free end, the free end being solid and coupled to the vibration part, and a fixed end coupled to the fixed part.

### CROSS-REFERENCE TO RELATED APPLICATIONS

This application claims the priority of Korean Patent Application No. 10-2011-0114058 filed on Nov. 3, 2011, in the Korean Intellectual Property Office, the disclosure of which is incorporated herein by reference.

### BACKGROUND OF THE INVENTION

1. Field of the Invention

The present invention relates to a linear vibrator, and more particularly, to a linear vibrator capable of generating vibrations when mounted in a portable electronic device and being used as a vibration generating device.

2. Description of the Related Art

Recently, the release of personal portable terminals having large LCD screens provided for user convenience has significantly increased. Accordingly, a touch screen scheme has been adopted therein, and a vibration motor has been used so as to generate vibrations when a touch is applied to a touch screen.

The vibration motor converts electrical energy into mechanical vibrations using a principle of generating electromagnetic force, and is mounted in the personal portable terminal to be used for silent incoming signal notification.

In a vibration motor according to the related art, a method in which a rotation part of an unbalanced mass is rotated by generating rotational force to thereby obtain mechanical vibrations has been used, and the rotational force is subjected to a rectifying action via a contact point between a brush and a commutator to thereby obtain the mechanical vibrations.

However, a brush-type structure using the commutator may cause mechanical friction and electrical sparks as well as the generation of foreign objects when the brush passes through a clearance between segments of the commutator when the motor is rotated, so that the service life of the motor may be shortened.

In addition, since it takes time to reach an amount of target vibrations due to rotational inertia when voltage is applied to the motor, there may be a problem in which a sufficient amount of vibrations for the touch screen may not be implemented.

A linear vibrator is widely used to implement a vibration function in the touch screen, while overcoming disadvantages in the service life and response properties of the motor.

The linear vibrator does not use a motor rotation principle, but generates resonance by periodically generating, in accordance with resonant frequencies, electromagnetic force obtained through a spring installed inside the linear vibrator and a mass body suspended on the spring, thereby generating vibrations.

In accordance with the market trend demanding miniaturization and slimness in portable electronic devices, this linear vibrator needs to be slim and be able to be efficiently produced, and performance and characteristics of the linear vibrator should not be affected, even in the case in which several factors act thereupon.

However, in the case of the linear vibrator according to the related art, the performance and characteristics of the vibrator are changed due to components vibrating in an interior space, which has also an effect on the performance of portable electronic devices using the linear vibrator.

Therefore, research into a technology for allowing the performance and characteristics of a linear vibrator to be unchanged, even with components vibrating in an interior space of the linear vibrator, has been urgently demanded.

### SUMMARY OF THE INVENTION

An aspect of the present invention provides a linear vibrator capable of implementing stable linear vibrations by preventing contact between a fixed part and a vibration part while simultaneously preventing a change in performance and characteristics thereof caused by vibrating components to secure a maximum amount of vibrations.

According to an aspect of the present invention, there is provided a linear vibrator including: a fixed part including a magnet generating magnetic force in an interior space having a predetermined size; a vibration part including a coil provided to face the magnet and generating electromagnetic force through interaction with the magnet, and a mass body; an elastic member coupled to the vibration part and the fixed part to thereby provide elastic force thereto; and a substrate including a free end, the free end being solid and coupled to the vibration part, and a fixed end coupled to the fixed part.

According to an aspect of the present invention, there is provided a linear vibrator including: a fixed part including a magnet generating magnetic force in an interior space having a predetermined size; a vibration part including a coil provided to face the magnet and generating electromagnetic force through interaction with the magnet, and a mass body; an elastic member coupled to the vibration part and the fixed part to thereby provide elastic force thereto; and a substrate including a free end coupled to the vibration part and having a hole formed therein and having a size smaller than that of an outer diameter of the magnet, and a fixed end coupled to the fixed part.

The free end may be coupled to the mass body.

The linear vibrator may further include a damping part provided on at least one of the free end and the fixed part facing the free end in order to prevent contact between the vibration part and the fixed part.

The damping part may be formed of at least one of rubber, cork, propylene, and poron.

The damping part may be formed by applying a magnetic fluid to a magnetic sheet.

The fixed end may include a copper foil pattern portion, such that the copper foil pattern portion and the fixed part are coupled to each other.

The copper foil pattern portion and the fixed part may be coupled to each other by at least one of a soldering method, a welding method, and a bonding method.

The fixed part may include an exposure hole penetrating through top and bottom surfaces thereof so that the copper foil pattern portion is exposed to the outside or an exposure groove formed by being depressed from an outer edge of the fixed part.

The copper foil pattern portion may be coupled to a portion of the fixed part defining the exposure hole or the exposure groove by a soldering method.

The fixed part may include a case providing the interior space and having an open bottom and a bracket sealing the interior space and including a protrusion portion protruded to an outside of the case, and the exposure hole or the exposure groove may be formed in the protrusion portion, and the copper foil pattern portion may be coupled to a part of the protrusion portion defining the exposure hole or the exposure groove by a soldering method.

The linear vibrator may further include a holder coupled to the mass body to thereby support the mass body.

The elastic member may be coupled to the holder by a welding method.

The fixed part may include a case providing the interior space and having an open bottom and a bracket sealing the interior space and including a protrusion portion protruded to an outside of the case, and the magnet may be provided on a top interior surface of the case.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is an exploded perspective view schematically showing a linear vibrator according to an embodiment of the present invention;

FIG. 2 is a cut-away perspective view schematically showing the linear vibrator according to the embodiment of the present invention;

FIG. 3 is a cross-sectional view schematically showing the linear vibrator according to the embodiment of the present invention;

FIG. 4 is a perspective view schematically showing a substrate provided in the linear vibrator according to the embodiment of the present invention;

FIG. 5 is an exploded perspective view schematically showing a coupling relationship between a mass body and the substrate provided in the linear vibrator according to the embodiment of the present invention;

FIG. 6 is a bottom exploded perspective view schematically showing a bracket provided in the linear vibrator according to the embodiment of the present invention;

FIG. 7 is a bottom perspective view schematically showing a coupling process between a deformable bracket and the substrate provided in the linear vibrator according to the embodiment of the present invention;

FIG. 8 is a bottom exploded perspective view schematically showing the bracket and the substrate provided in the linear vibrator according to the embodiment of the present invention;

FIG. 9 is a bottom perspective view schematically showing a coupling process of the bracket and the substrate of FIG. 8; and

FIG. 10 is a schematic cross-sectional view showing a linear vibrator according to another embodiment of the present invention.

### DETAILED DESCRIPTION OF THE INVENTION

Embodiments of the present invention will now be described in detail with reference to the accompanying drawings. However, it should be noted that the spirit of the present invention is not limited to the embodiments set forth herein and those skilled in the art and understanding the present invention can easily accomplish retrogressive inventions or other embodiments included in the spirit of the present invention by the addition, modification, and removal of components within the same spirit, but those are construed as being included in the spirit of the present invention.

Further, like reference numerals will be used to designate like components having similar functions throughout the drawings within the scope of the present invention.

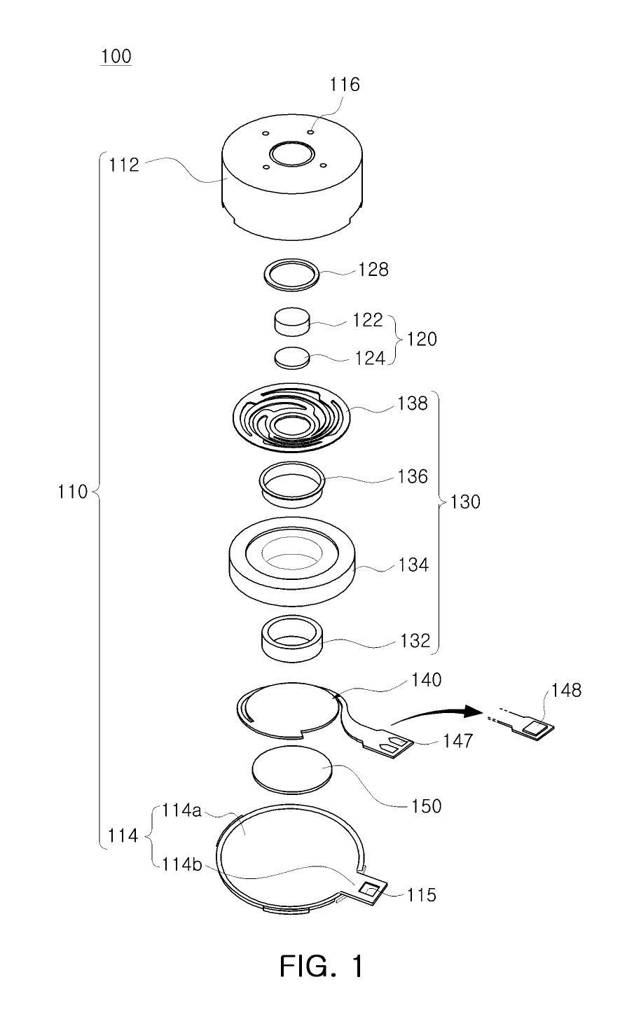

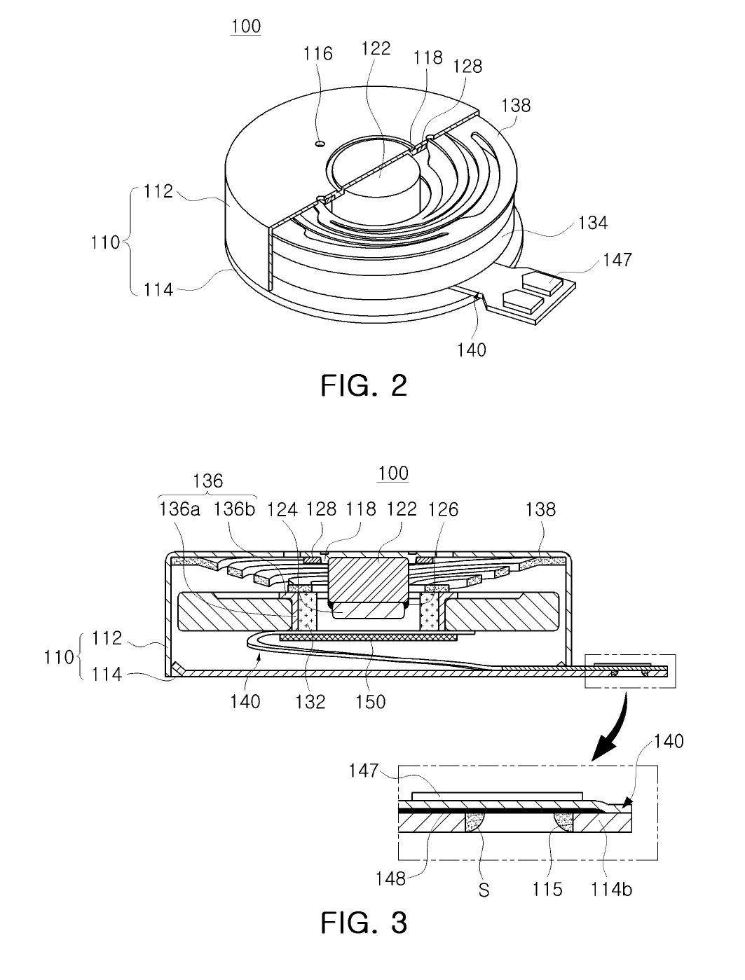

FIG. 1 is an exploded perspective view schematically showing a linear vibrator according to an embodiment of the present invention. FIG. 2 is a cut-away perspective view schematically showing the linear vibrator according to the embodiment of the present invention. FIG. 3 is a cross-sectional view schematically showing the linear vibrator according to the embodiment of the present invention.

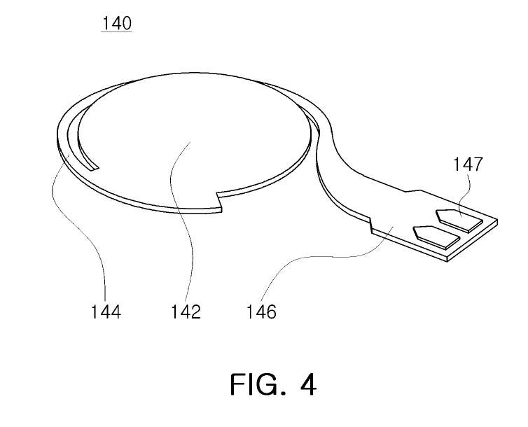

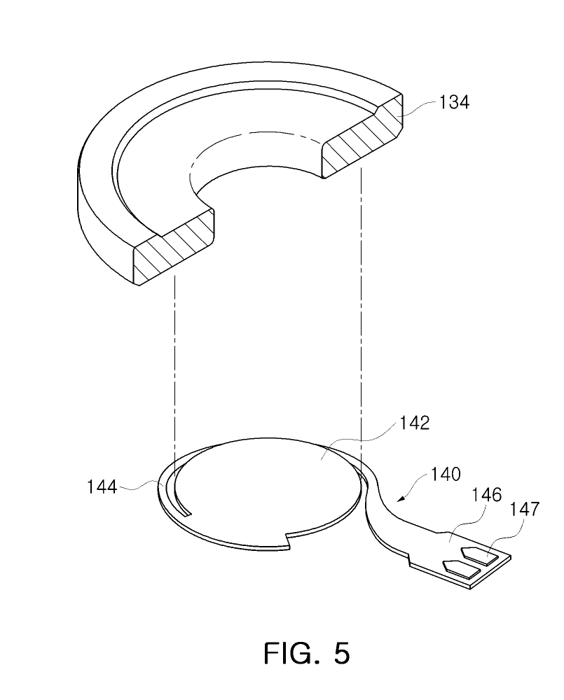

In addition, FIG. 4 is a perspective view schematically showing a substrate provided in the linear vibrator according to the embodiment of the present invention. FIG. 5 is an exploded perspective view schematically showing a coupling relationship between a mass body and the substrate provided in the linear vibrator according to the embodiment of the present invention.

First, in defining terms regarding directions, an outer diameter direction or inner diameter direction is a direction toward an outer circumferential surface of a case 112 from the center of the case 112 or vice versa.

Referring to FIGS. 1 through 5, a linear vibrator 100 according to the embodiment of the present invention may include a fixed part 110 forming an exterior of the linear vibrator 100 and including a magnet 122 of a magnetic field part 120, a vibration part 130 including a coil 132 and a mass body 134, an elastic member 138 providing elastic force, and a substrate 140 allowing power to be applied to the coil 132.

The fixed part 110 may provide an interior space having a predetermined size, and specifically, may include the case 112 having an open bottom and a bracket 114 sealing the interior space formed by the case 112.

Here, a space accommodating the magnetic field part 120 including the magnet 122, the vibration part 130, and the like may be formed by the case 112 and the bracket 114. The case 112 and the bracket 114 may be integrally formed.

In addition, in a top surface of the case 112, at least one inflow hole 116 for disposing a magnetic fluid 126, which will be described later, on an outer circumferential surface of the magnet 122 may be formed, and the outer circumferential surface of the magnet 122 may be easily coated with the magnetic fluid 126 through the inflow hole 116.

In addition, the inflow hole 116 may allow a laser beam to penetrate therethrough, which is required when the elastic member 140 and a holder 136 of the vibration part 130 are coupled by welding.

Meanwhile, the case 112 may include a contact preventing portion 128 provided on a top interior surface thereof so as to prevent contact between the vibration part 130 and the case 112 of the fixed part 110, according to vibrations of the vibration part 130.

The contact preventing portion 128 may be formed of an elastic material to prevent contact caused by a linear movement of the vibration part 130 and may prevent contact noise from being generated when the vibration part 130 contacts the case 112 by excessive vibrations of the vibration part 130 and at the same time, prevent abrasion of the vibration part 130.

Here, the contact preventing portion 128 may be formed of various kinds of material, such as rubber, cork, propylene, phorone, or the like, which may absorb impacts, in order to absorb external impacts applied to the case when external impacts are applied thereto.

Meanwhile, the bracket 114 may include a sealing portion 114a sealing the open bottom of the case 112, and a protrusion portion 114b protruding outwardly of the case 112 after being coupled therewith.

The protrusion portion 114b may include an exposure hole 115 penetrating a top surface and a bottom surface thereof, for soldering coupling with a copper foil pattern portion 148 formed on the substrate 140.

When the substrate 140 and the protrusion portion 114b are brought into contact with each other, the exposure hole 115 may expose, to the outside, the copper foil pattern portion 148 formed on the substrate 140, so that the copper foil pattern portion 148 and the protrusion portion 114b are coupled by soldering.

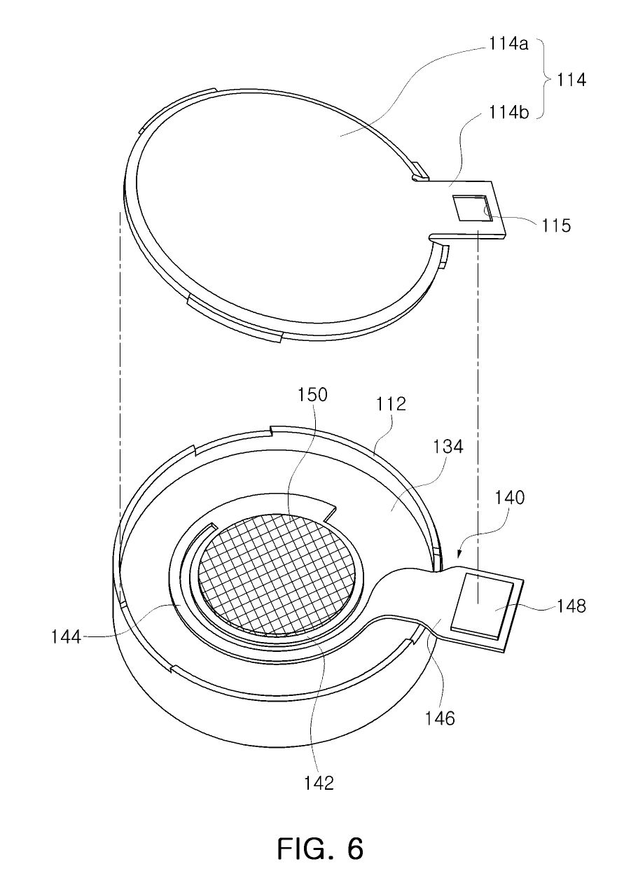

As described above, the coupling relationship between the substrate 140 including the copper foil pattern portion 148 and the bracket 114 including the protrusion portion 114b will be described in detail later with reference to FIGS. 6 through 9.

The magnet 122 and a yoke plate 125 may constitute the magnetic field part 120 of the linear vibrator 100 according to the embodiment of the present invention, and the magnet 122 may be coupled to the top surface of the bracket 114 constituting the fixed part 110 by at least one of bonding, pressing, and welding.

The magnet 122 may have an outer diameter smaller than an inner diameter of the coil 132 coupled to the holder 136 and be provided on the top interior surface of the case 112.

Here, an outer wall 118 that is protruded to correspond to the outer diameter of the magnet 122 may be provided on the top interior surface of the case 112. Therefore, an outer peripheral surface of the magnet 122 is inserted into and fixed to an inner surface of the outer wall 118, whereby the magnet 112 and the case 112 may be more firmly coupled to each other.

Meanwhile, the elastic member 138 providing elastic force to the vibration part 130 may have a hole formed in the center thereof, the hole having a size larger than the outer diameter of the magnet 122 in order to prevent contact between the elastic member 138 and the magnet 122 at the time of a vertical vibration of the vibration part 130.

In addition, a bottom surface of the magnet 122 may be coupled to the yoke plate 124 allowing magnetic flux to smoothly flow to the magnet 122 through a coil 132 generating electromagnetic force by interaction with the magnet 122.

The yoke plate 124 may be formed of a magnetic material, thereby facilitating coating of the magnetic fluid 126.

That is, the magnetic fluid 126 may be coated between the outer circumferential surfaces of the magnet 122 and the yoke plate 124 and the coil 132, and the magnetic fluid 126 may prevent abnormal vibrations of the vibration part 130.

Specifically, the magnetic fluid 126 may be disposed in a clearance formed between the magnet 122 and the coil 132 so as to facilitate a vertical movement of the vibration part 130, and may prevent the abnormal vibrations generated by the lateral or vertical movement of the vibration part 130 due to factors such as an external impact, and the like.

The magnetic fluid 126 may be a substance which converges at the magnetic flux of the magnet 122, and when the surface of the magnet 122 is coated with the magnetic fluid 126, the magnetic fluid 126 may converge at a generation point of the magnetic flux of the magnet 122 to thereby form a single ring.

Here, the magnetic fluid 126 may be obtained such that a magnetic powder is dispersed in a liquid in a colloidal state, and then a surfactant is added thereto, so that precipitation or agglomeration of the magnetic powder due to gravity, a magnetic field, or the like, may not occur. As an example of the magnetic fluid 126, a triiron tetraoxide and a material prepared by dispersing iron-cobalt alloy particles in oil or water are used. Recently, a material prepared by dispersing cobalt in toluene is used.

The magnetic powder may be ultra-fine powder, and allow for a unique Brownian motion of ultra-fine particles, so that a concentration of magnetic powder particles in the fluid may be maintained to be constant, even in the case of the application of an external magnetic field, gravity, centrifugal force, or the like.

In addition, the magnetic fluid 126 may fill a gap between an outer surface of the magnet 122 and an inner surface of a hollow of the coil 132, so that the vibration part 130 may vibrate smoothly or slide.

The vibration part 130 may include the coil 132 and the mass body 134, at least one of the coil 132 and the mass body 134 may be fixed by the holder 136, and mediation of the vibration may be implemented by the elastic member 138.

That is, the vibration part 130 may be a member that vibrates vertically via the elastic member 138.

The coil 132 may be disposed to face the magnet 122, and a part of the magnet 122 may be inserted into a space formed by the coil 132.

Here, the coil 132 may have the inner diameter larger than the outer diameter of the magnet 122, and the coil 132 and the magnet 122 may be maintained in a non-contact state while the vibration part 130 moves.

In addition, the coil 132 may be coupled to an inner surface of a hollow of the holder 136, and induce a magnetic field therearound when a current is applied thereto in accordance to a predetermined frequency.

In this case, when electromagnetic force is excited through the coil 132, magnetic flux passing through the coil 132 from the magnet 122 may be formed in a lateral direction, and the magnetic field generated by the coil 132 may be formed in a vertical direction, so that the vibration part 130 may vibrate vertically.

Accordingly, the magnetic flux direction of the magnet 122 and the vibration direction of the vibration part 130 may be perpendicular to each other.

That is, through the application of the electromagnetic force having the same vibrational frequency as a natural mechanical frequency of vibrations of the vibration part 130, the vibration part 130 may resonate and vibrate to obtain a maximum vibrational quantity, and the natural frequency of vibrations of the vibration part 130 may be affected by a mass of the vibration part 130 and an elastic modulus of the elastic member 138.

Here, current applied to the coil 132 of the vibration part 130, that is, external power having a predetermined frequency, may be supplied by the substrate 140 coupled to the vibration part 130.

The holder 136 may be coupled to an outer circumferential surface of the coil 132 to fixedly support the mass body 134, and may be formed to have a hollow cylindrical shape having open top and bottom.

More specifically, the holder 136 may include a cylindrical vertical portion 136a coupled to the outer peripheral surface of the coil 132 and an inner peripheral surface of the mass body 134 and a horizontal portion 136b extended from an end of the cylindrical vertical portion 136a in the outer diameter direction to thereby support a top surface of the mass body 134.

In addition, the holder 136 may be formed of a material including iron, and formed of the same material as that of the elastic member 138 to thereby allow for tight coupling to easily be performed.

However, the material of the holder 136 and the elastic member 138 is not limited thereto, and any material may be used as long as the coupling may be easily and tightly performed.

The mass body 134 may be a vibration body that is coupled to an outer surface of the vertical portion 136a and a bottom surface of the horizontal portion 136b of the holder 136 to vibrate vertically. Here, when the mass body 134 vibrates vertically, the mass body 134 may have an outer diameter smaller than an inner diameter of the inner surface of the case 112, so as to allow for vibrations without contact within the fixed part 110.

Therefore, a clearance having a predetermined size may be formed between the inner surface of the case 112 and the outer surface of the mass body 134.

The mass body 134 may be formed of a nonmagnetic material or a paramagnetic material which is not affected by a magnetic force generated by the magnet 122.

Accordingly, the mass body 134 may be formed of a material such as tungsten having a denser mass than that of steel, and this is because a resonance frequency is adjusted by increasing the mass of the vibration part 130 within the same volume, and a vibration quantity is maximized.

However, the material of the mass body 134 is not limited to tungsten, and various materials may be used therefor, depending on the designer's intent.

The elastic member 138 is a member coupled to the vibration part 130 and the fixed part 110, that is, the holder 136 and the case 112 as described above to thereby provide elastic force thereto. The elastic modulus of the elastic member 138 has an effect on a natural frequency of the vibration part 130.

Here, the elastic member 137 may be any one of a coil spring and a leaf spring. However, the elastic member 137 is not limited thereto but may be any member capable of providing the elastic force.

In addition, the elastic member 138 and the holder 136 may be coupled to each other by welding.

The substrate 140 may be coupled to a bottom surface of the mass body 134 configuring the vibration part 130, and a lead wire of the coil 132 is electrically connected to an electrode pad (not shown), such that an electrical signal having a predetermined frequency may be transferred to the coil 132.

Here, the electrode pad (not shown) may be formed on the outside of the outer diameter of the coil 132 and may be electrically connected to one end of the lead wire of the coil 132 by soldering.

Accordingly, the lead wire of the coil 132 may be coupled with the electrode pad 140 on the outside of the coil 132, so there is no influence on vibrations and movement when the linear vibrator 100 according to the embodiment of the present invention is operated.

More specifically, the substrate 140 may be a flexible printed circuit board and include a free end 142 and a fixed end 146 coupled to the fixed part 110. The free end 142 is coupled to the vibration part 130 and may be solid, or may have a hole formed therein, the hole having a size smaller than that of the outer diameter of the magnet 122.

The fixed end 146 may include a power connection terminal 147 for supplying power to the coil 132 and may be protruded to the outside of the case 112.

In addition, the substrate 140 may include a connecting end 144 connecting the free end 142 and the fixed end 146 to each other.

The connecting end 144 may turn from an edge of the fixed end 146 in a circumferential direction of the free end 142, while retaining a predetermined clearance between the connecting end 144 and the free end 142, thereby allowing the free end 142 to vibrate vertically.

Here, the free end 142 may be a portion of the substrate 140 coupled to the mass body 134 of the vibration part 130 by a coupling method such as a bonding method, or the like, to thereby vibrate together with the vibration part 140 according to vibrations of the vibration part 130, and may also contact and be coupled to the coil 132 or the holder 136 together with the mass body 134.

Meanwhile, the free end 142 of the substrate 140 may be solid as described above or may be in the form of a thin film having a hole formed therein, the hole having a size smaller than that of the outer diameter of the magnet 122.

Therefore, since the free end 142 may be solid or have a hole formed therein and having a size smaller than that of the outer diameter of the magnet 122 to allow for an increase in a contact area of the vibration part 130.

In other words, since the free end 142 is a portion of the substrate vibrating together with the vibration part 130, coupling force between the free end 142 and the vibration part 130 is a very important factor that has an effect on a stable linear vibration of the vibration part 130.

Therefore, in order to increase the coupling force between the free end 142 and the vibration part 130, a contact area between the free end 142 and the vibration part 130, that is, the mass body 134, needs to be significantly increased.

In addition, as necessary, since the free end 142 may also be coupled to the coil 132 or the holder 136, the free end 142 needs to have a contact area with the coil 132 or the holder 136.

Therefore, the substrate 140 of the linear vibrator 100 according to the embodiment of the present invention includes the free end 142 formed to be solid or having the hole formed therein and having a size smaller than that of the outer diameter of the magnet 122, whereby a contact area for coupling between the substrate 140 and the mass body 134 may be significantly increased and a contact area between the substrate 140 and the coil 132 or the holder 136 may be provided.

As a result, coupling force between the vibration part 130 and the substrate 140 may be significantly increased.

In addition, the substrate 140 of the linear vibrator 100 according to the embodiment of the present invention includes the free end 142 formed to be solid or having the hole formed therein and having a size smaller than that of the outer diameter of the magnet 122, whereby rigidity of the substrate 140 may be improved and noise generated in the linear vibrator 100 may be reduced.

In other words, due to the free end 142 formed to be solid or having the hole with a size smaller than that of the outer diameter of the magnet 122, an area of the substrate 140 may be increased, whereby deformation of the substrate 140 such as cutting thereof, or the like, may be prevented even in the case in which external impacts, or the like, are applied to the linear vibrator 100.

In addition, since the free end 142 of the substrate 140, formed to be solid or having the hole with a size smaller than that of the outer diameter of the magnet 122 may have flexible properties, when noise is generated in the linear vibrator 100, the free end 142 may be elastically deformed in itself to thereby reduce the noise.

Further, in the linear vibrator 100 according to the embodiment of the present invention, the free end 142 of the substrate 140 formed to be solid or having the hole with a size smaller than that of the outer diameter of the magnet 122 may provide a coupling space in which a damping part 150 to be described below may be coupled thereto.

The damping part 150 may prevent contact between the vibration part 130 and the bracket 114, which is a component of the fixed part 110 according to vibrations of the vibration part 130, and may be provided on at least one of the free end 142 of the substrate 140 and the fixed part 110 facing the free end 142.

The damping part 150 may be formed of an elastic material so as to prevent contact between the vibration part 130 and the bracket 114 due to the linear movement of the vibration part 130, external impacts, or the like. Here, the damping part 150 may prevent abrasion of the vibration part 130 simultaneously with preventing contact noise from being generated due to contact between the vibration part 130 and the bracket 114 caused by excessive vibrations of the vibration part 130.

More specifically, the damping part 150 may be formed of at least one of rubber, cork, propylene, and poron so as to absorb impact.

Here, the damping part 150 may be coupled to the free end 142 of the substrate 140, and a coupling area between the damping part 150 and the free end 142 needs to be significantly increased in order to significantly increase coupling stability, or the like.

In consideration of this, in the linear vibrator 100 according to the embodiment of the present invention, the free end 142 of the substrate 140 is formed to be solid or has the hole with a size smaller than that of the outer diameter of the magnet 122, whereby a coupling area between the free end 142 and the damping part 150 may be significantly increased.

Meanwhile, the fixed end 146 of the substrate 140 may include the copper foil pattern portion 148 to thereby be coupled to the bracket 114, which is a component of fixed part 110. A detailed description thereof will be provided with reference to FIGS. 6 through 9.

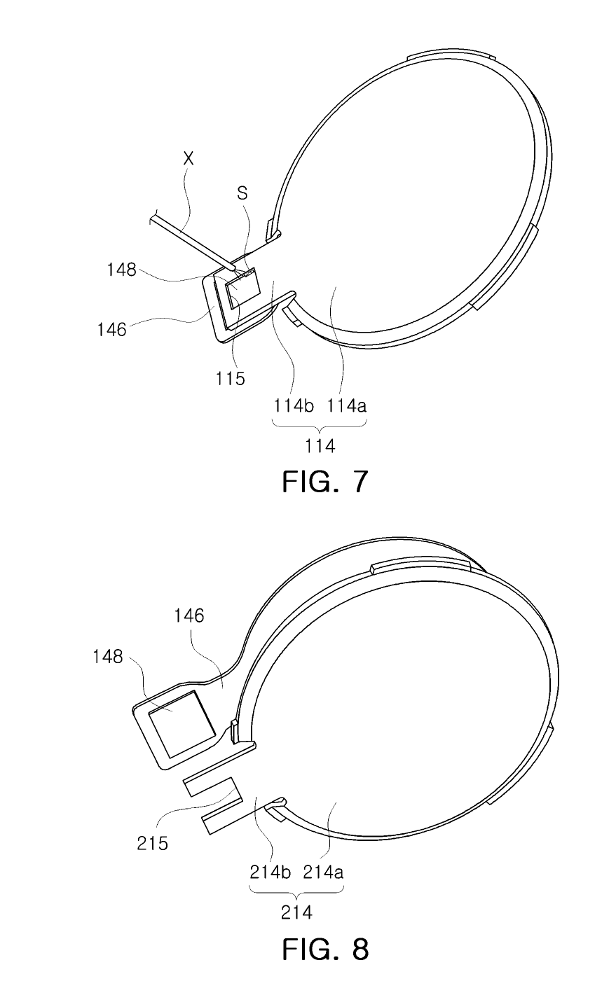

FIG. 6 is a bottom exploded perspective view schematically showing a bracket provided in the linear vibrator according to the embodiment of the present invention. FIG. 7 is a bottom perspective view schematically showing a coupling process between a deformable bracket and the substrate provided in the linear vibrator according to the embodiment of the present invention.

Referring to FIGS. 6 and 7, the fixed end 146 of the substrate 140 of the linear vibrator 100 according to the embodiment of the present invention may include the copper foil pattern portion 148, which may be coupled to the bracket 114 of the fixed part 110.

Here, the fixed end 146 may include the power connection terminal 147 provided on a top surface thereof, the power connection terminal 147 supplying power to the coil 132 and being protruded the outside of the case 112.

More specifically, the fixed end 146 may include the copper foil pattern portion 148 provided on a bottom surface thereof so as to be coupled to the bracket 114 of the fixed part 110, and the copper foil pattern portion 148 may be a thin copper plate.

In other words, the copper foil pattern portion 148 may be provided on one surface of the substrate 140 on which the substrate 140 and the fixed part 110 contact, that is, on the bottom surface of the fixed end 146 of the substrate 140 contacting the bracket 114 of the fixed part 110.

Here, the bracket 114 may include the sealing portion 114a sealing the interior space of the case 112 having the open bottom and the protrusion portion 114b protruding from an outer edge of the sealing portion 114a in the outer diameter direction to thereby be protruded to the outside of the case 112.

Therefore, the fixed end 146 of the substrate 140 may be coupled to the protrusion portion 114b, and the substrate 140 of the linear vibrator 100 according to the embodiment of the present invention may include the copper foil pattern portion 148 in order to couple the fixed end 146 and the protrusion portion 114b to each other.

That is, since the substrate 140 provided in the embodiment of the present invention may be the flexible printed circuit board, the substrate 140 may be highly susceptible to heat.

Accordingly, in the related art, an adhesive has been used to couple the substrate to the protrusion portion of the bracket, and in this case, when an external impact is applied to the substrate, problems may arise in the linear vibration of the vibration part, due to a change in an initial position of the substrate.

In addition, the substrate may be deformed and damaged due to the heat required for curing the adhesive.

To overcome the above-described problems, fixation of the substrate 140 with the bracket 114 of the fixed part 110 may be secured, and the linear vibrator 100 according to the embodiment of the present invention may include the copper foil pattern portion 148 on the bottom surface of the fixed end 146, so that the copper foil pattern portion 148 and the protrusion portion 114b of the bracket 114 are coupled.

That is, the copper foil pattern portion 148 provided on the bottom surface of the fixed end 146 of the substrate 140 may be coupled to the protrusion portion 114b by solder (S) through soldering using a soldering tool X, and for the convenience of the soldering, the protrusion portion 114b of the bracket 114 may have the exposure hole 115 penetrating the top surface and the bottom surface thereof.

When the fixed end 146 of the substrate 140 and the protrusion portion 114b are coupled, the exposure hole 115 may expose, to the outside, the copper foil pattern portion 148 provided on the bottom surface of the fixed end 146.

Accordingly, the copper foil pattern portion 148 and a part of the protrusion portion 114b defining the exposure hole 115 may be tightly coupled by the solder (S) through soldering to thereby allow for tight coupling of the fixed end 146 and the protrusion portion 114b.

However, various coupling methods other than the above-described coupling method through soldering between the copper foil pattern portion 148 and the protrusion portion 114b for coupling between the fixed end 146 and the protrusion portion 114b, within a range which does not cause the deformation of the substrate 140, may be adopted.

That is, the copper foil pattern portion 148 provided on the fixed end 146 and the protrusion portion 114b may be coupled by welding, and specifically, coupled by arc welding using heat generated by arc discharge, gas welding using a gas mixture of oxygen and acetylene, electron beam welding in which a high-speed electron beam is formed in a vacuum and the energy inherent in the electron flow is used as a welding heat source, laser beam welding which is performed by amplifying light in which a phase coincides as a single wavelength, friction welding using friction heat generated in a contact surface by causing a relative rotational movement, or the like.

Other than these, a coupling method using ultrasonic welding, pressure welding, high-frequency welding, or the like, may be used.

Further, the copper foil pattern portion 148 provided on the fixed end 146 and the protrusion portion 114b may be coupled by bonding using an adhesive.

Here, the adhesive may be a UV bonding adhesive such as Loctite, LP163, LI504, or the like, and may be a metal bonding adhesive such as Loctite, epoxy, an adhesive only for UHU metal, or the like.

In addition, as for the coupling method between the copper foil pattern portion 148 of the fixed end 146 and the protrusion portion 114b, at least two of the above-described coupling methods may be used simultaneously.

Since the fixed end 146 and the protrusion portion 114b are coupled through the above-described coupling method, an initial position of the substrate 140 may not be changed, even in the case that an external impact is applied to the substrate 140. That is, there is no influence or changes with regard to vibration performance and characteristics of the linear vibrator 100 according to the embodiment of the present invention by the vibration of the substrate 140, that is, a vibrating component.

Here, radial cross-sectional shapes of the exposure hole 115 formed in the protrusion portion 114b and of the copper foil pattern portion 148 may not be limited to the rectangular shape shown in FIGS. 1 through 4, and a variety of shapes such as a polygonal shape, a circular shape, or the like, other than the rectangular shape, may be used.

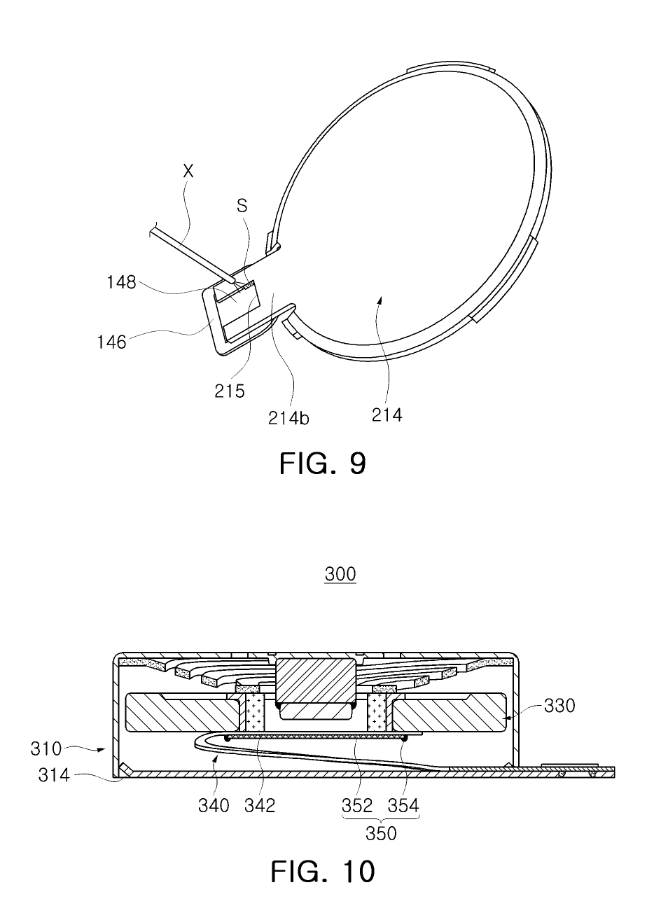

FIG. 8 is a bottom exploded perspective view schematically showing the bracket and the substrate provided in the linear vibrator according to the embodiment of the present invention. FIG. 9 is a bottom perspective view schematically showing a coupling process of the bracket and the substrate of FIG. 8.

Referring to FIGS. 8 and 9, a deformable bracket 214 provided in the linear vibrator 100 according to the embodiment of the present invention may include an exposure groove 215 exposing the copper foil pattern portion 148 provided on the bottom surface of the fixed end 146 of the substrate 140 to the outside.

The exposure groove 215 may be formed by being depressed from an outer edge of a protrusion portion 214b of the bracket 214 at a predetermined depth in the inner diameter direction.

Therefore, the fixed end 146 of the substrate 140 and the protrusion portion 214b may be firmly coupled to each other by solder (S) through soldering between the copper foil pattern portion 148 and a part of the protrusion portion 214b defining the exposure groove 215, using the soldering tool X.

In addition, the copper foil pattern portion 148 and a part of the protrusion portion 214b defining the exposure groove 215 may also be coupled to each other by the coupling methods by various weldings or bonding described with reference to FIGS. 6 and 7 in addition to the soldering.

However, a radial cross-sectional of the exposure groove 215 is not limited to having a rectangular shape shown in FIGS. 8 and 9, but may have various shapes such as a polygonal shape, a circular shape, or the like, in addition to the rectangular shape.

FIG. 10 is a schematic cross-sectional view showing a linear vibrator according to another embodiment of the present invention.

Referring to FIG. 10, a linear vibrator 300 according to another embodiment of the present invention has the same components and effect as those of the linear vibrator 100 according to the embodiment of the present invention described with reference to FIGS. 1 through 9 except for a damping part 350. Therefore, a description except for the damping part 350 will be omitted.

The damping part 350 may be provided on at least one of a free end 342 of a substrate 340 and a fixed part 310 thereof, facing the free end 342.

The damping part 350 may include a magnet sheet 352 and a magnetic fluid 354 so as to prevent contact between a vibration part 330 and a bracket 314 due to a linear movement of the vibration part 330, external impacts, or the like.

That is, the damping part 350 may be implemented by attaching the magnet sheet 352 on a bottom surface of the free end 342 and then applying the magnetic fluid 354 to the magnet sheet 352.

Here, the magnetic fluid 354 is naturally collected on an outside of the magnet sheet 352 by magnetic force of the magnet sheet 352. As a result, in the case in which the magnetic fluid 354 is applied on one surface of the magnet sheet 352, it may be collected at a magnetic flux generation point of the magnet sheet 352 to thereby form one annular shape.

Due to the damping part 350 including the magnet sheet 352 and the magnetic fluid 354 as described above, the linear vibrator 300 according to another embodiment of the present invention may prevent abrasion of the vibration part 330 simultaneously with preventing contact noise from being generated due to contact between the vibration part 330 and the bracket 314 caused by excessive vibrations of the vibration part 330.

As set forth above, with the linear vibrator according to the embodiments of the present invention, coupling force between a substrate and a component corresponding thereto is improved, whereby stability of the substrate can be increased.

In addition, deformation of the substrate may be prevented due to vibrations of the vibration part or application of external impacts.

Further, contact between the fixed part and the vibration part is prevented, whereby a maximum vibrational quantity may be secured.

Furthermore, noise is reduced from a substrate constitution itself, whereby stable linear vibrations can be implemented.

While the present invention has been shown and described in connection with the embodiments, it will be apparent to those skilled in the art that modifications and variations can be made without departing from the spirit and scope of the invention as defined by the appended claims.

What is claimed is:

1. A linear vibrator comprising:
a fixed part including a magnet generating magnetic force in an interior space having a predetermined size;
a vibration part including a coil provided to face the magnet and generating electromagnetic force through interaction with the magnet, and a mass body;
an elastic member coupled to the vibration part and the fixed part to thereby provide elastic force thereto; and
a substrate including a free end, the free end being solid and coupled to the vibration part, and a fixed end coupled to the fixed part.

2. The linear vibrator of claim 1, wherein the free end is coupled to the mass body.

3. The linear vibrator of claim 1, further comprising a damping part provided on at least one of the free end and the fixed part facing the free end in order to prevent contact between the vibration part and the fixed part.

4. The linear vibrator of claim 3, wherein the damping part is formed of at least one of rubber, cork, propylene, and poron.

5. The linear vibrator of claim 3, wherein the damping part is formed by applying a magnetic fluid to a magnetic sheet.

6. The linear vibrator of claim 1, wherein the fixed end includes a copper foil pattern portion, such that the copper foil pattern portion and the fixed part are coupled to each other.

7. The linear vibrator of claim 6, wherein the copper foil pattern portion and the fixed part are coupled to each other by at least one of a soldering method, a welding method, and a bonding method.

8. The linear vibrator of claim 6, wherein the fixed part includes an exposure hole penetrating through top and bottom surfaces thereof so that the copper foil pattern portion is exposed to the outside or an exposure groove formed by being depressed from an outer edge of the fixed part.

9. The linear vibrator of claim 8, wherein the copper foil pattern portion is coupled to a portion of the fixed part defining the exposure hole or the exposure groove by a soldering method.

10. The linear vibrator of claim 6, wherein the fixed part includes a case providing the interior space and having an open bottom and a bracket sealing the interior space and including a protrusion portion protruded to an outside of the case, and
the exposure hole or the exposure groove is formed in the protrusion portion, and the copper foil pattern portion is coupled to a part of the protrusion portion defining the exposure hole or the exposure groove by a soldering method.

11. The linear vibrator of claim 1, further comprising a holder coupled to the mass body to thereby support the mass body.

12. The linear vibrator of claim 11, wherein the elastic member is coupled to the holder by a welding method.

13. The linear vibrator of claim 1, wherein the fixed part includes a case providing the interior space and having an open bottom and a bracket sealing the interior space and including a protrusion portion protruded to an outside of the case, and
the magnet is provided on a top interior surface of the case.

14. A linear vibrator comprising:
a fixed part including a magnet generating magnetic force in an interior space having a predetermined size;
a vibration part including a coil provided to face the magnet and generating electromagnetic force through interaction with the magnet, and a mass body;
an elastic member coupled to the vibration part and the fixed part to thereby provide elastic force thereto; and
a substrate including a free end coupled to the vibration part and having a hole formed therein and having a size smaller than that of an outer diameter of the magnet, and a fixed end coupled to the fixed part.

15. The linear vibrator of claim 14, wherein the free end is coupled to the mass body.

16. The linear vibrator of claim 14, further comprising a damping part provided on at least one of the free end and the fixed part facing the free end in order to prevent contact between the vibration part and the fixed part.

17. The linear vibrator of claim 16, wherein the damping part is formed of at least one of rubber, cork, propylene, and poron.

18. The linear vibrator of claim 16, wherein the damping part is formed by applying a magnetic fluid to a magnetic sheet.

19. The linear vibrator of claim 14, wherein the fixed end includes a copper foil pattern portion, such that the copper foil pattern portion and the fixed part are coupled to each other.

20. The linear vibrator of claim 19, wherein the copper foil pattern portion and the fixed part are coupled to each other by at least one of a soldering method, a welding method, and a bonding method.

21. The linear vibrator of claim 19, wherein the fixed part includes an exposure hole penetrating through top and bottom surfaces thereof so that the copper foil pattern portion is exposed to the outside or an exposure groove formed by being depressed from an outer edge of the fixed part.

22. The linear vibrator of claim 21, wherein the copper foil pattern portion is coupled to a portion of the fixed part defining the exposure hole or the exposure groove by a soldering method.

23. The linear vibrator of claim 19, wherein the fixed part includes a case providing the interior space and having an open bottom and a bracket sealing the interior space and including a protrusion portion protruded to an outside of the case, and
the exposure hole or the exposure groove is formed in the protrusion portion, and the copper foil pattern portion is coupled to a part of the protrusion portion defining the exposure hole or the exposure groove by a soldering method.

24. The linear vibrator of claim 14, further comprising a holder coupled to the mass body to thereby support the mass body.

25. The linear vibrator of claim 24, wherein the elastic member is coupled to the holder by a welding method.

26. The linear vibrator of claim 14, wherein the fixed part includes a case providing the interior space and having an open bottom and a bracket sealing the interior space and including a protrusion portion protruded to an outside of the case, and
the magnet is provided on a top interior surface of the case.
